(19) United States
(12) Patent Application Publication
(10) Pub. No.: US 2026/0121405 A1
(43) Pub. Date: Apr. 30, 2026

(54) CONTROL SYSTEM

(71) Applicant: Samsung Electronics Co., Ltd., Suwon-si (KR)

(72) Inventors: Dohyun Kim, Suwon-si (KR); Kyutae Kim, Suwon-si (KR); Sunwoo Rhee, Seoul-si (KR); Jungyong Lee, Seoul-si (KR); Younghoon Cho, Seoul-si (KR)

(73) Assignees: Samsung Electronics Co., Ltd., Suwon-si (KR); Konkuk University Industrial Cooperation Corp, Seoul (KR)

(21) Appl. No.: 19/003,675

(22) Filed: Dec. 27, 2024

(30) Foreign Application Priority Data
May 28, 2024 (KR) 10-2024-0069525

(51) Int. Cl. H02J 3/24; G05B 13/04

(52) U.S. Cl. CPC H02J 3/0014; G05B 13/048; H02J 2103/30

(57) ABSTRACT

A control system including a power grid configured to supply a grid voltage, a filter capacitor and a filter inductor each connected in parallel to the power grid, a filter current meter connected in series to the filter inductor, an active power filter connected to the filter current meter, a nonlinear load connected in series to the power grid, and a modulated model predictive controller (MMPC) configured to generate a control signal for operating the active power filter.

### CROSS-REFERENCE TO RELATED APPLICATION

This application is based on and claims priority under 35 U.S.C. § 119 to Korean Patent Application No. 10-2024-0069525, filed on May 28, 2024, in the Korean Intellectual Property Office, the disclosure of which is incorporated by reference herein in its entirety.

### BACKGROUND

Aspects of the inventive concept relate to a control system, and more particularly, to a control system using an active power filter including a modulated model predictive controller (MMPC).

For components that use direct current (DC) power, distortion due to harmonics flowing into a power grid is increasing. This distortion has various negative effects on electrical equipment including transformers, motors, etc. According to the related art, harmonics are suppressed using a proportional-resonant controller and a repetitive controller, but this method has limitations in coping with a wide bandwidth. Therefore, various technologies to optimize the suppression process have been proposed.

### SUMMARY

Aspects of the inventive concept provide a control system having improved reliability.

According to an aspect of the inventive concept, there is provided a control system including a power grid configured to supply a grid voltage, a filter capacitor and a filter inductor each connected in parallel to the power grid, a filter current meter connected in series to the filter inductor, an active power filter connected to the filter current meter, a nonlinear load connected in series to the power grid, and a modulated model predictive controller (MMPC) configured to generate a control signal for operating the active power filter.

According to another aspect of the inventive concept, there is provided a control system including a filter capacitor and a filter inductor each provided between a power grid and a nonlinear load and connected in parallel to the power grid, wherein the power grid and the nonlinear load are connected in series to each other, an active power filter connected in series to the filter inductor, a filter current meter located between the filter inductor and the active power filter, and an MMPC configured to generate a control signal for operating the active power filter, wherein the power grid is configured to supply a grid voltage to the nonlinear load, the filter inductor and the filter capacitor are connected in parallel to each other, and the MMPC includes a voltage controller to which a direct current (DC) link voltage command value and a DC link voltage measurement value are input.

According to another aspect of the inventive concept, there is provided a control system including a power grid configured to supply a grid voltage, a filter capacitor and a filter inductor each connected in parallel to the power grid, a filter current meter connected in series to the filter inductor, an active power filter connected to the filter current meter, a nonlinear load connected in series to the power grid, an MMPC configured to generate a control signal for operating the active power filter, and a load current meter located between the power grid and the nonlinear load, wherein the filter inductor and the filter capacitor are connected in parallel to each other, and the MMPC includes a voltage controller to which a DC link voltage command value and a DC link voltage measurement value are input, and a minimum cost function calculator to which an electric current command value is input, and wherein the electric current command value is output from the voltage controller, and the minimum cost function calculator uses a DC link voltage, a sampling frequency, and an electric current measurement value during a calculation process.

### BRIEF DESCRIPTION OF THE DRAWINGS

Embodiments will be more clearly understood from the following detailed description taken in conjunction with the accompanying drawings in which:

FIG. 1 is a circuit diagram of a control system according to an embodiment;

FIG. 2 is a conceptual diagram illustrating a control processing sequence of a modulated model predictive controller (MMPC) in the control system according to an embodiment;

FIG. 3 is a graph illustrating a relationship between a duty and a square of error used in the control system according to an embodiment;

FIG. 4 shows waveforms of control simulation results of an active power filter including an MMPC in the control system according to an embodiment;

FIG. 5 shows waveforms of control simulation results of an active power filter including an MMPC in a control system according to an embodiment;

FIG. 6 shows waveforms of control simulation results of an active power filter including an MMPC in a control system according to an embodiment;

FIG. 7 is a flowchart showing a control method of the control system, according to an embodiment; and

FIG. 8 is a flowchart showing a detailed process for selecting an optimal duty in the control method of the control system according to an embodiment.

### DETAILED DESCRIPTION OF THE EMBODIMENTS

The embodiments may have diverse changes and various forms, and thus, some embodiments are illustrated in the drawings and described in detail. However, this is not intended to limit the embodiments to some specific embodiments. Also, embodiments described below are only examples, and thus, various changes may be made from the embodiments.

All examples or illustrative terms are only used to describe the technical idea in detail, and thus, the scope of the inventive concept is not limited by these examples or illustrative terms unless limited by the claims.

As used herein, unless otherwise specified, a vertical direction may be defined as a Z direction, and a first horizontal direction and a second horizontal direction may each be defined as a horizontal direction perpendicular to the Z direction. The first horizontal direction may be referred to as an X direction and the second horizontal direction may be referred to as a Y direction. A vertical level may refer to a height level in the vertical direction Z. A horizontal width may refer to a length in the horizontal direction X and/or Y and a vertical length may refer to a length in the vertical direction Z.

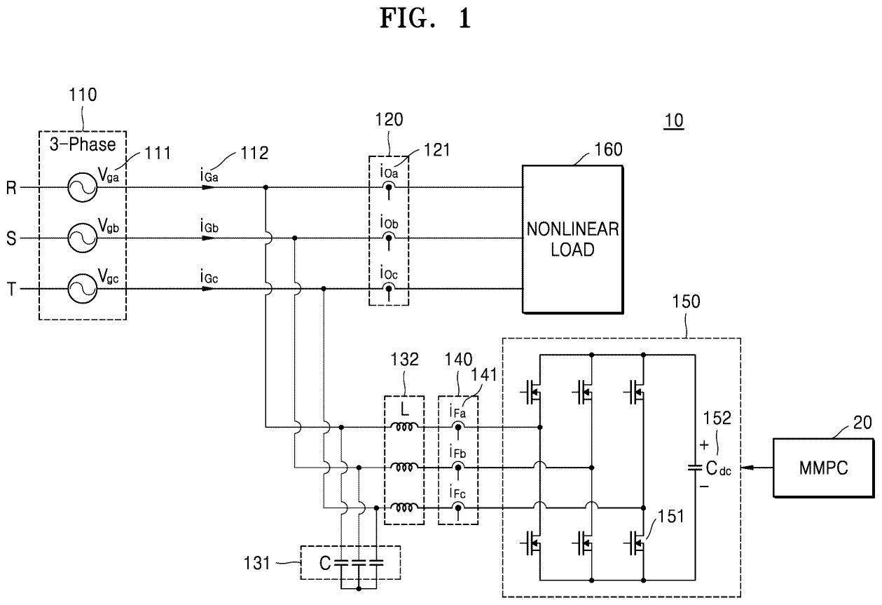

FIG. 1 is a circuit diagram of a control system 10 according to an embodiment.

Referring to FIG. 1, a control system 10 according to aspects of the inventive concept may include a power grid 110. The power grid 110 may supply grid voltages 111. The grid voltages 111 may include 3-phase voltages. The grid voltages 111 may be expressed as V_{ga}, V_{gb}, and V_{gc}. Grid voltage V_{ga} may represent an R phase. Grid voltage V_{gb} may represent an S phase. Grid voltage V_{gc} may represent a T phase. The R phase, S phase, and T phase may have a phase difference of 120° from each other. The grid voltages 111 may respectively generate grid currents 112. The grid currents 112 may be expressed as i_{Ga}, i_{Gb}, and i_{Gc}. In this case, grid current i_{Ga} may correspond to grid voltage V_{ga}, grid current i_{Gb} may correspond to grid voltage V_{gb}, and grid current i_{Gc} may correspond to grid voltage V_{gc}. The grid voltages 111 may be supplied to a nonlinear load 160, which is described below.

The control system 10 may further include a passive power filter that includes a filter inductor 132 and a filter capacitor 131. Each of the filter inductor 132 and the filter capacitor 131 may be connected in parallel to the power grid 110. That is, the power grid 110 and the nonlinear load 160 may be connected in series to each other. The filter inductor 132 may be connected in parallel between the power grid 110 and the nonlinear load 160. The filter capacitor 131 may be connected in parallel between the power grid 110 and the nonlinear load 160. The filter inductor 132 and the filter capacitor 131 may be connected in parallel to each other. However, the embodiment is not limited thereto. In some embodiments, the filter inductor 132 and the filter capacitor 131 may be connected in series to each other. The filter inductor 132 may include a plurality of inductors. The inductors in the filter inductor 132 may be respectively and electrically connected to the phases of the power grid 110. The filter capacitor 131 may include a plurality of capacitors. The capacitors in the filter capacitor 131 may be respectively and electrically connected to the phases of the power grid 110.

The control system 10 may include a filter current meter 140 that is connected in series to the filter inductor 132. The filter current meter 140 may be configured to measure filter currents 141 that are supplied to the nonlinear load 160 from an active power filter 150, which is described later. The filter currents 141 may be respectively expressed as i_{Fa}, i_{Fb}, and i_{Fc}. Filter current i_{Fa} may correspond to grid voltage V_{ga}, filter current imp may correspond to grid voltage V_{gb}, and filter current i_{Fc} may correspond to grid voltage V_{gc}.

The control system 10 may include the active power filter 150. The active power filter 150 may be connected in series to the filter current meter 140. That is, the filter current meter 140 may be located between the filter inductor 132 and the active power filter 150. Also, the control system 10 may include a modulated model predictive controller (MMPC) 20 that is configured to generate a control signal for operating the active power filter 150. The active power filter 150 may include a plurality of legs connected in parallel to each other. Each of the legs may include two switching elements 151, and the two switching elements 151 may be connected in series to each other. The legs of the active power filter 150 may correspond to the filter current meter 140. In an embodiment, the leg including the switching elements located closest to the filter current meter 140 may correspond to filter current i_{Fa}. In an embodiment, the leg including the switching elements located farthest from the filter current meter 140 may correspond to filter current i_{Fc}. In an embodiment, the leg including the switching elements located second farthest from the filter current meter 140 may correspond to filter current i_{Fb}. The active power filter 150 may be configured to supply the filter current 141 to the passive power filter, including the filter inductor 132 and the filter capacitor 131, via the switching element 151 and a direct current (DC) link capacitor 152. Each of the switching elements 151 may include an active element. In an embodiment, the switching element 151 may include a metal-oxide-semiconductor field-effect transistor (MOSFET). In an embodiment, the switching element 151 may include an insulated gate bipolar transistor (IGBT). The active power filter 150 may reduce harmonics by means of a grid-connected inverter including the switching element 151.

The active power filter 150 may compensate for harmonic currents, which are generated by the nonlinear load 160 in the power grid 110, by using the voltage charged to the DC link capacitor 152. Accordingly, the grid currents 112 may be made into a sine wave, and the quality of the grid may be improved.

The nonlinear load 160 may receive load currents 121 from the power grid 110 and the active power filter 150. The control system 10 may further include a load current meter 120 located between the power grid 110 and the nonlinear load 160 and configured to measure the load currents 121. The load currents 121 may respectively correspond to three phases of the power grid 110 or may respectively correspond to the grid currents 112 or may respectively correspond to the filter currents 141. The load currents 121 may be respectively expressed as i_{Oa}, i_{Ob}, and i_{Oc}. Load current i_{Oa} may correspond to grid voltage V_{ga}, load current ion may correspond to grid voltage V_{gb}, and load current i_{Oc} may correspond to grid voltage V_{gc}. Load current i_{Oa} may also correspond to filter current i_{Fa}, load current i_{Ob} may also correspond to filter current i_{Fb}, and load current i_{Oc} may also correspond to filter current i_{Fc}. For example, each of the load currents 121 may be expressed as the sum of the grid current 112 supplied by the power grid 110 and the filter current 141 supplied by the active power filter 150. In an embodiment, one of the load currents 121, i_{Oa}, may be expressed as the sum of grid current i_{Ga} and filter current i_{Fa}. In an embodiment, one of the load currents 121, job, may be expressed as the sum of grid current i_{Gb} and filter current i_{Fb}. In an embodiment, one of the load currents 121, i_{Oc}, may be expressed as the sum of grid current i_{Gc} and filter current i_{Fc}. Although not shown in the diagram, the nonlinear load 160 may include a rectifier. In addition, although not shown in the diagram, the nonlinear load 160 may include a resistive load.

The MMPC 20 may generate a control signal for operating the switching element 151. The control signal generated by the MMPC 20 may include a pulse width modulation (PWM) waveform. The MMPC 20 may be configured to change the maximum frequency of the control signal.

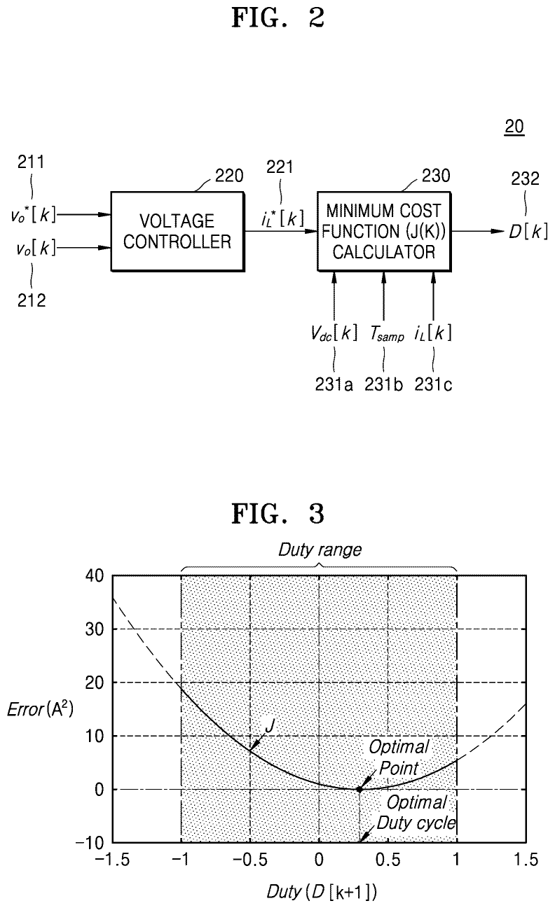

FIG. 2 is a conceptual diagram illustrating a control processing sequence of an MMPC 20 in a control system according to an embodiment.

FIG. 2 is described with reference to FIG. 1. The MMPC 20 may include a voltage controller 220. A DC link voltage command value 211 and a DC link voltage measurement value 212 may be input to the voltage controller 220. The DC link voltage command value 211 may be expressed as vₒ*[k]. The DC link voltage measurement value 212 may be expressed as vₒ[k]. The DC link voltage command value 211 represents the DC link voltage value that is input by a user. The DC link voltage measurement value 212 represents the voltage value that is measured on the active power filter 150. The MMPC 20 may include a minimum cost function (J(k)) calculator 230 (hereinafter, referred to as a minimum cost function calculator 230) to which an electric current command value 221 is input. That is, during the process of calculating the minimum cost function, the MMPC 20 according to aspects of the inventive concept uses an electric current command rather than a voltage command. The electric current command value 221 according to aspects of the inventive concept may be output from the voltage controller 220. The electric current command value 221 may be expressed as i_{L}*[k]. i_{L} may represent the electric current that flows through an inductor in the filter inductor 132. In addition, the electric current command value 221, i_{L}*[k], represents the value of the electric current input by a user. Through the electric current command value 221, i_{L}*[k], the minimum cost function calculator 230 may perform the calculation using the cost function J(k). Also, an optimal duty (i.e., duty cycle) 232 that minimizes the error of the output current may be selected by the calculation of the minimum cost function calculator 230. According to aspects of the inventive concept, the duty 232 may be expressed as D[k]. During the process of calculating the cost function J(k) by the minimum cost function calculator 230, a DC link voltage 231a, a sampling frequency 231b, and an electric current measurement value 231c may be used. The DC link voltage 231a may be expressed as V_{dc}[k]. The sampling frequency 231b may be expressed as Tₛₐₘₚ. The electric current measurement value 231c may be expressed as i_{L}[k]. The DC link voltage 231a, V_{dc}[k], represents the DC voltage that is applied to a terminal of the DC link capacitor 152. The sampling frequency 231b, Tₛₐₘₚ, represents a frequency as an input reference, for example. The electric current measurement value 231c, i_{L}[k], may represent a measurement value of the electric current that flows through the inductor in the filter inductor 132.

The MMPC 20 includes a controller structure that outputs the value of the duty 232 that minimizes the value of the extracted cost function J(k).

In general, a transfer function of an AC/DC system having an LC filter structure is as shown in Equation 1.

$${v}_{a b} = {L}_{f} \frac{d {i}_{L}}{d t} + R {i}_{L} + {v}_{o} \qquad [ Equation 1 ]$$

Herein, v_{ab} represents the voltage applied to the upper end, and L_{f} represents the inductance applied to the filter. R represents the resistance, and i_{L} represents the electric current flowing in the filter inductor. vₒ represents the output voltage.

Applying the Euler forward approximation method to Equation 1, the equation may be expanded as in Equation 2.

$${i}_{L} [ k + 1 ] = {i}_{L} [ k ] + \frac{{T}_{s a m p}}{{L}_{f}} ( {v}_{a b} [ k ] - {v}_{o} [ k ] ) \qquad [ Equation 2 ]$$

Herein, k represents a step. That is, step k+1 represents the step after step k. The step represents a point in time. In an embodiment, i_{L}[k+1] represents the electric current flowing in the filter inductor at the k+1th step. In an embodiment, i_{L}[k] represents the electric current flowing in the filter inductor at the kth step. In an embodiment, v_{ab}[k] represents the pole voltage at the kth step. In an embodiment, vₒ[k] represents the output voltage at the kth step.

When the 3-level half bridge inverter topology is applied to Equation 2, the pole voltage may be expressed as

$$D [ k ] \frac{{V}_{d c} [ k ]}{2} .$$

Herein, D[k] represents the kth duty value. For the 2-level, this value may be expressed as D[k]V_{dc}[k]. According to aspects of the inventive concept, if the equation is expanded assuming the 3-level topology, Equation 3 and Equation 4 may be obtained.

$${i}_{L} [ k + 1 ] = {i}_{L} [ k ] + \frac{{T}_{s a m p}}{{L}_{f}} ( D [ k ] \cdot \frac{{V}_{d c} [ k ]}{2} - {v}_{o} [ k ] ) \qquad [ Equation 3 ]$$

$${i}_{L} [ k + 2 ] = {i}_{L} [ k + 1 ] + \frac{{T}_{s a m p}}{{L}_{f}} ( D [ k + 1 ] \cdot \frac{{V}_{d c} [ k ]}{2} - {v}_{o} [ k ] ) \qquad [ Equation 4 ]$$

Equation 4 represents the system function at the k+2th point in time. The frequencies of V_{dc}[k] and vₒ[k] may be very low compared to the sampling frequency 231b, Tₛₐₘₚ. Therefore, the value at the k+1th sampling point is assumed to be the kth sampling value. If the cost function J is derived using the state equation of the derived system, a result as in Equation 5 may be obtained.

$$J = {( {i}_{L}^{*} [ k + 2 ] - {i}_{L} [ k + 2 ] )}^{2} \qquad [ Equation 5 ]$$

Herein, in an embodiment,

$${i}_{L}^{*} [ k + 2 ]$$

represents the electric current command value at the k+2th point in time. In an embodiment, i_{L}[k+2] represents the electric current measurement value at the k+2th point in time. As in Equation 5, when the sampling value at the k+2th point in time of i_{L} is substituted into the cost function J, the equation may be expressed as a second-order equation having a duty D as a variable. Also, applying the gradient descent to the second-order equation, the point in time, at which the differential value of the equation expressed in duty becomes 0, may be determined as the minimum value of the cost function J. That is, the equation for finding the minimum value of the cost function J is as shown in Equation 6 below.

$$D [ k + 1 ] = D [ k ] - 2 {L}_{f} \frac{{i}_{L}^{*} [ k + 2 ] - {i}_{L} [ k ]}{{V}_{d c} [ k ] {T}_{s a m p}} - \frac{2 {V}_{o} [ k ]}{{V}_{d c} [ k ]} \qquad [ Equation 6 ]$$

FIG. 3 is a graph illustrating the relationship between a duty and a square of error used in a control system according to an embodiment.

FIG. 3 is described below together with reference to FIGS. 1 and 2.

In FIG. 3, the x-axis represents the magnitude of the duty 232 and the y-axis represents the square of error. More specifically, the x-axis of the graph in FIG. 3 represents the magnitude of D[k+1], which is the k+1th step of the duty 232. The range of the duty 232 may be assumed to be about −1 to about 1. In the full range of the magnitude of the duty 232, a curve graph may be formed not only for the previously specified range about −1 to about 1, but also for other ranges. Also, the curve graph may represent the cost function J. The cost function J may have a minimum value within the range of the duty 232. The optimal point at which the cost function J has the minimum value represents the value at which the slope of the duty 232 is 0. That is, the optimal point at which the cost function J has the minimum value may represent the point at which the error is minimized. The value of the duty 232 of the optimal point at which the error is minimized may represent an optimal duty cycle.

In FIG. 3 according to the inventive concept, the y-axis value at the optimal point, which is the square of error, is shown as 0, but the value of the optimal point is not limited to the diagram. Also, although FIG. 3 illustrates that the optimal duty cycle corresponding to the optimal point is formed in a range of about 0 to about 0.5, the value of the optimal duty cycle is not limited to the diagram.

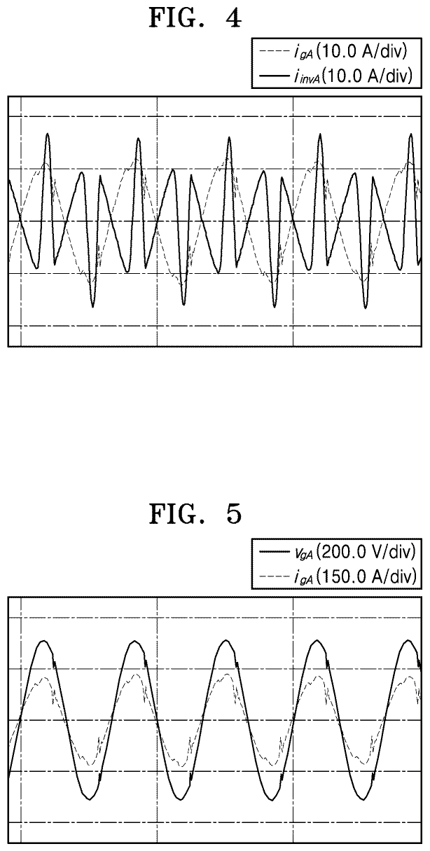

FIG. 4 shows waveforms of control simulation results of an active power filter including an MMPC in the control system 10 according to an embodiment. FIG. 5 shows waveforms of control simulation results of an active power filter including an MMPC in the control system according 10 to an embodiment.

FIGS. 4 and 5 are described below together with reference to FIGS. 1 to 3. An i_{invA} waveform of FIG. 4 represents the harmonic current compensated for by the active power filter 150. The i_{invA} waveform may include a PWM waveform. i_{gA} waveforms of FIGS. 4 and 5 represent the grid currents 112 which are made into sine waves by the input harmonic current. FIG. 4 illustrates the electric current according to harmonic compensation. Examining the i_{gA} waveform, it can be seen that as the active power filter 150 compensates, the grid current 112 is restored to an almost complete fundamental sine wave form (a fundamental frequency).

A v_{gA} waveform of FIG. 5 represents the grid voltage 111. Examining the v_{gA} waveform and the i_{gA} waveform, it can be seen that these waveforms are controlled so that frequencies or periods are similar, with only the amplitudes and waveforms being different.

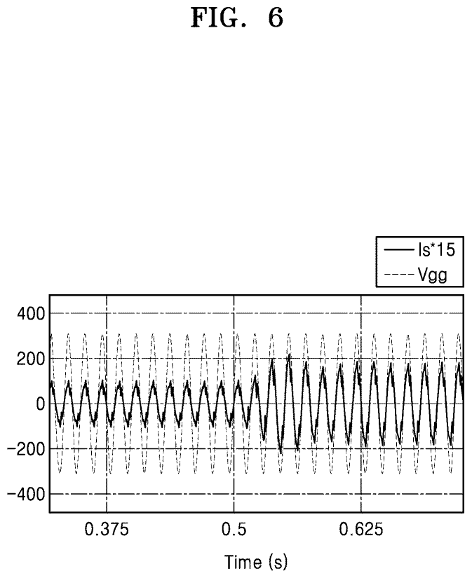

FIG. 6 shows waveforms of control simulation results of an active power filter including an MMPC in a control system according to an embodiment.

Referring to FIG. 6 together with FIGS. 1 to 5, this shows the resulting waveform when the electric current command is changed into steps. Iₛ*15 represents the electric current command changed into steps. Since the electric current command and the voltage waveform are controlled such that the frequencies or periods become almost similar to each other as shown in FIG. 5, the performance of the MMPC 20 according to aspects of the inventive concept may be confirmed.

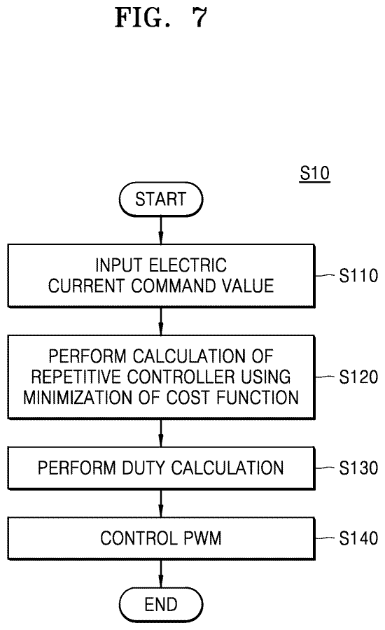

FIG. 7 is a flowchart showing a control method of the control system 10, according to an embodiment.

Referring to FIG. 7 together with FIG. 1 and FIG. 2, a control method (S10) using the control system 10 may include operation S110 of inputting the electric current command value 221. The electric current command value 221 input during operation S110 may be an input value of the minimum cost function calculator 230 as illustrated in FIG. 2. The control method (S10) may include operation S120 of operating a repetitive controller using the minimization of cost function. The repetitive controller in operation S120 may correspond to the minimum cost function calculator 230 of FIG. 2. The control method (S10) may include operation S130 for calculating the duty 232 and operation S140 for controlling the PWM, which is a control signal, by using the duty 232 derived in operation S130. The control method (S10) may be performed by the MMPC 20 that includes the voltage controller 220 and the minimum cost function calculator 230, as illustrated in FIG. 2.

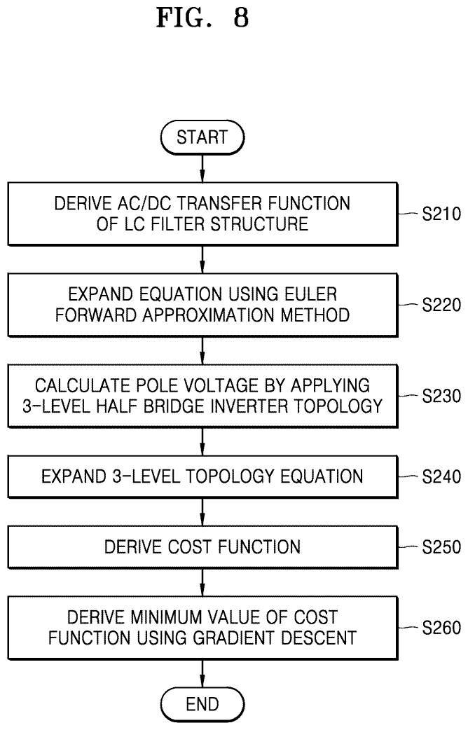

FIG. 8 is a flowchart showing a detailed process for selecting an optimal duty in the control method of the control system 10 according to an embodiment.

Operations shown in FIG. 8 may respectively correspond to operations of obtaining Equations described in FIG. 2. In operation S210, the AC/DC transfer function of the LC filter structure is derived, and Equation 1 is derived. In operation S220 performed after operation S210, the equation is expanded by the Euler forward approximation method, and Equation 2 is derived. In operation S230 performed after operation S220, the pole voltage is calculated by applying the 3-level half bridge inverter topology, and

$$D [ k ] \frac{{V}_{d c} [ k ]}{2}$$

described above is derived. In operation S240 performed after operation S230, the 3-level topology equation is expanded, and Equation 4 described above is derived using

$$D [ k ] \frac{{V}_{d c} [ k ]}{2}$$

derived in operation S230. In operation S250 performed after operation S240, the cost function is derived, and Equation 5 is derived. Finally, in operation S260, the minimum value of the cost function is derived by the gradient descent, and Equation 6 described above is derived. The above-described operations may be repeated a plurality of times.

While aspects of the inventive concept have been particularly shown and described with reference to embodiments thereof, it will be understood that various changes in form and details may be made therein without departing from the spirit and scope of the following claims.

What is claimed is:

1. A control system comprising:
a power grid configured to supply a grid voltage;
a filter capacitor and a filter inductor each connected in parallel to the power grid;
a filter current meter connected in series to the filter inductor;
an active power filter connected to the filter current meter;
a nonlinear load connected in series to the power grid; and
a modulated model predictive controller (MMPC) configured to generate a control signal for operating the active power filter.

2. The control system of claim 1, wherein the filter inductor and the filter capacitor are connected in parallel to each other.

3. The control system of claim 1, wherein the MMPC comprises a voltage controller to which a direct current (DC) link voltage command value and a DC link voltage measurement value are input.

4. The control system of claim 1, wherein the MMPC comprises a minimum cost function calculator to which an electric current command value is input, and
the electric current command value is output from a voltage controller.

5. The control system of claim 4, wherein the minimum cost function calculator uses a DC link voltage, a sampling frequency, and an electric current measurement value during a calculation process.

6. The control system of claim 4, wherein the minimum cost function calculator is configured to select a duty based on a cost function derived during a calculation process, and
the MMPC is further configured to generate the control signal based on the duty.

7. The control system of claim 6, wherein the minimum cost function calculator is configured to calculate, using gradient descent, a minimum value of the cost function derived during the calculation process.

8. The control system of claim 1, further comprising a load current meter located between the power grid and the nonlinear load.

9. The control system of claim 1, wherein the active power filter comprises:
a plurality of legs connected in parallel to each other; and
a DC link capacitor connected in parallel to each of the plurality of legs.

10. The control system of claim 9, wherein each of the plurality of legs comprises two switching elements connected in series to each other.

11. A control system comprising:
a filter capacitor and a filter inductor each provided between a power grid and a nonlinear load and connected in parallel to the power grid, wherein the power grid and the nonlinear load are connected in series to each other;
an active power filter connected in series to the filter inductor;
a filter current meter located between the filter inductor and the active power filter; and
a modulated model predictive controller (MMPC) configured to generate a control signal for operating the active power filter,
wherein the power grid is configured to supply a grid voltage to the nonlinear load,
the filter inductor and the filter capacitor are connected in parallel to each other, and
the MMPC comprises a voltage controller to which a direct current (DC) link voltage command value and a DC link voltage measurement value are input.

12. The control system of claim 11, wherein the MMPC comprises a minimum cost function calculator to which an electric current command value is input,
the electric current command value is output from the voltage controller, and
the minimum cost function calculator uses a DC link voltage, a sampling frequency, and an electric current measurement value during a calculation process.

13. The control system of claim 12, wherein the minimum cost function calculator is configured to select a duty based on a cost function derived during the calculation process, and
the MMPC is further configured to generate the control signal based on the duty.

14. The control system of claim 13, wherein the control signal has a pulse-width modulation (PWM) waveform, and
the MMPC is further configured to change a maximum frequency of the control signal.

15. The control system of claim 13, wherein the minimum cost function calculator is configured to calculate, using gradient descent, a minimum value of the cost function derived during the calculation process.

16. The control system of claim 11, further comprising a load current meter located between the power grid and the nonlinear load, and configured to measure a load current,
wherein the load current is defined as a sum of a grid current supplied by the power grid and a filter current measured by the filter current meter.

17. The control system of claim 11, wherein the active power filter comprises:
a plurality of legs connected in parallel to each other; and
a DC link capacitor connected in parallel to each of the plurality of legs, and
wherein each of the plurality of legs comprises two switching elements connected in series to each other.

18. The control system of claim 17, wherein each switching element comprises, as an active element, either a metal-oxide-semiconductor field-effect transistor (MOSFET) or an insulated gate bipolar transistor (IGBT).

19. A control system comprising:
a power grid configured to supply a grid voltage;
a filter capacitor and a filter inductor each connected in parallel to the power grid;
a filter current meter connected in series to the filter inductor;
an active power filter connected to the filter current meter;
a nonlinear load connected in series to the power grid;
a modulated model predictive controller (MMPC) configured to generate a control signal for operating the active power filter; and
a load current meter located between the power grid and the nonlinear load,
wherein the filter inductor and the filter capacitor are connected in parallel to each other, and
the MMPC comprises:
a voltage controller to which a direct current (DC) link voltage command value and a DC link voltage measurement value are input; and
a minimum cost function calculator to which an electric current command value is input, and
wherein the electric current command value is output from the voltage controller, and
the minimum cost function calculator uses a DC link voltage, a sampling frequency, and an electric current measurement value during a calculation process.

20. The control system of claim 19, wherein the minimum cost function calculator is configured to:
select a duty based on a cost function derived during the calculation process; and
calculate, using gradient descent, a minimum value of the cost function derived during the calculation process, and
wherein the MMPC is further configured to:
generate, based on the duty, the control signal having a pulse-width modulation (PWM) waveform; and
change a maximum frequency of the control signal.
